(19) United States
(12) Patent Application Publication
(10) Pub. No.: US 2017/0099342 A1
(43) Pub. Date: Apr. 6, 2017

(54) Dynamically Served Content

(71) Applicants: Anthony Ko-Ping Chien, Foster City, CA (US); Kevin A. Li, New York, NY (US)

(72) Inventors: Anthony Ko-Ping Chien, Foster City, CA (US); Kevin A. Li, New York, NY (US)

(21) Appl. No.: 15/283,304

(22) Filed: Oct. 1, 2016

Related U.S. Application Data
(60) Provisional application No. 62/236,910, filed on Oct. 4, 2015.

(51) Int. Cl. H04L 29/08; G06F 17/30

(52) U.S. Cl. CPC H04L 67/06; G06F 17/30867; G06F 17/30899; H04L 67/02; H04L 67/42

(57) ABSTRACT

Methods, systems, and products determine a best version of webpage. A webpage may have many different versions, with each different version tailored to parameters associated with a client device. A database of content associates the different versions to different combinations and/or ranges of the parameters. When the client device requests the webpage, the parameters are retrieved and the corresponding version is selected and sent.

### CROSS-REFERENCE TO RELATED APPLICATIONS

This application claims the benefit of U.S. Provisional Application 62/236,910 filed Oct. 4, 2015. This application also relates to U.S. application Ser. No. 14/991,079 filed Jan. 8, 2016, to U.S. application Ser. No. 15/055,917 filed Feb. 29, 2016, and to U.S. application Ser. No. 15/138,364 filed Apr. 26, 2016. All these applications are incorporated herein by reference in their entireties.

### BACKGROUND

Traditional AB testing is flawed. Webpages are traditionally produced in a few versions and served to requesters. One of the versions is then chosen, based on any decisional metric (such as conversion). All traffic is then directed to the chosen version of the webpage. However, many customers may have better responded to the “losing” version. That is, eyeballs are lost based on an imperfect traditional test.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIGS. 2-6 are more detailed schematics illustrating the operating environment, according to exemplary embodiments; and

FIG. 7 is a flowchart illustrating a method or algorithm for clustering versions of a webpage, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

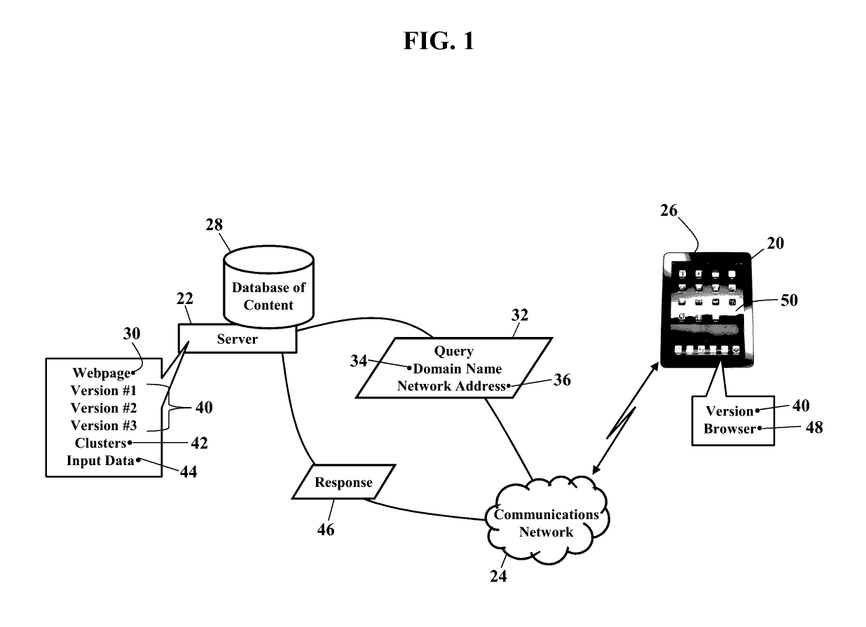

FIG. 1 is a schematic illustrating an environment in which exemplary embodiments may be implemented. FIG. 1 illustrates a client device 20 that communicates with a server 22 via a communications network 24. The client device 20, for simplicity and familiarity, is illustrated as a mobile tablet computer 26. The client device 20, however, may be any other mobile or stationary device, as later paragraphs will explain. Regardless, the server 22 stores a database 28 of content. When a user of the tablet computer 26 wishes to retrieve some webpage 30, the user's tablet computer 26 submits a query 32 to the server 22. The query 32 includes or specifies a domain name 34 and/or a network address 36 associated with the webpage 30. For example, if the query 32 specifies the domain name 34, the domain name 34 is resolved into the network address 36 (as DNS resolution is well known). Regardless, when the server 22 receives the query 32, the server 22 queries the database 28 of content for the network address 36.

Here, though, exemplary embodiments may specify different versions 40 of the webpage 30. That is, even though the tablet computer 26 requests the webpage 30, there may be multiple different versions 40 associated with the webpage 30. FIG. 1, for simplicity, only illustrates several different versions of the webpage 30. In actual practice, though, there may be hundreds or even thousands of different versions 40. Each different version 40 may be customized or tailored to appeal to different clusters 42 of users. The server 22 gathers all kinds of input data 44, which later paragraphs will explain. The input data 44 is analyzed to determine which cluster 42 best appeals to, or represents, the user of the tablet computer 26. Once the cluster 42 is determined, the server 22 then selects the version 40 that corresponds to the cluster 42. That is, the server 22 classifies the input data 44 and dynamically chooses the version 40 of the webpage 30. The server 22 may retrieve the corresponding version 40 of the webpage 30, or the server 22 may redirect the query 32 to another network location storing the version 40 of the webpage 30. Regardless, the version 40 of the webpage 30 is sent as a response 46 to the network address associated with the tablet computer 26. The tablet computer 26 renders the version 40 of the webpage 30 using a software application (such as a web browser 48) for display on a display device 50. The tablet computer 26 thus audibly and/or visually presents the version 40 of the webpage 30 that best appeals to the user.

Exemplary embodiments thus present much finer granularity. Conventional techniques utilize a “winner take all” philosophy in which one or a few webpage versions are chosen for all requests. Here, though, machine learning uses computation to determine the version 40 that best suites the individual user. The different versions 40 associated with the webpage 30 may be finely tuned to appeal to their respective cluster 42. That is, there may be many different clusters 42, with each different cluster 42 associated with different input data 44. Even a slight difference in the input data 44 may be associated with a different cluster 42. The number of the different clusters 42 is really only limited by effort and resources. Hence there may be hundreds or even thousands of different clusters 42, with each cluster 42 associated with a different version 40 of the webpage 30. Each different version 40 may thus have some layout, content, and/or other difference chosen to appeal to the corresponding input data 44.

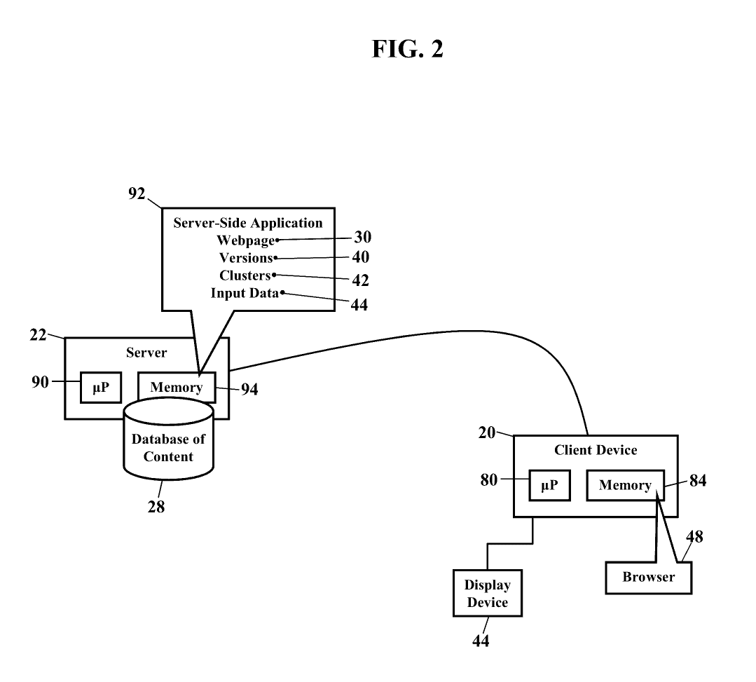

FIGS. 2-6 are more detailed schematics illustrating the operating environment, according to exemplary embodiments. Here the client device 20 is generically illustrated as any system or device having a processor 80 (e.g., “μP”), application specific integrated circuit (ASIC), or other component that executes the web browser 48 stored in a local memory 84. The server 22 may also have a processor 90 (e.g., “μP”), application specific integrated circuit (ASIC), or other component that executes a server-side application 92 stored in a local memory 94. The web browser 48 and/or the server-side application 92 include algorithms, instructions, code, and/or programs that cooperate and to perform operations, such as selecting the version 40 of the webpage 30 based on the input data 44.

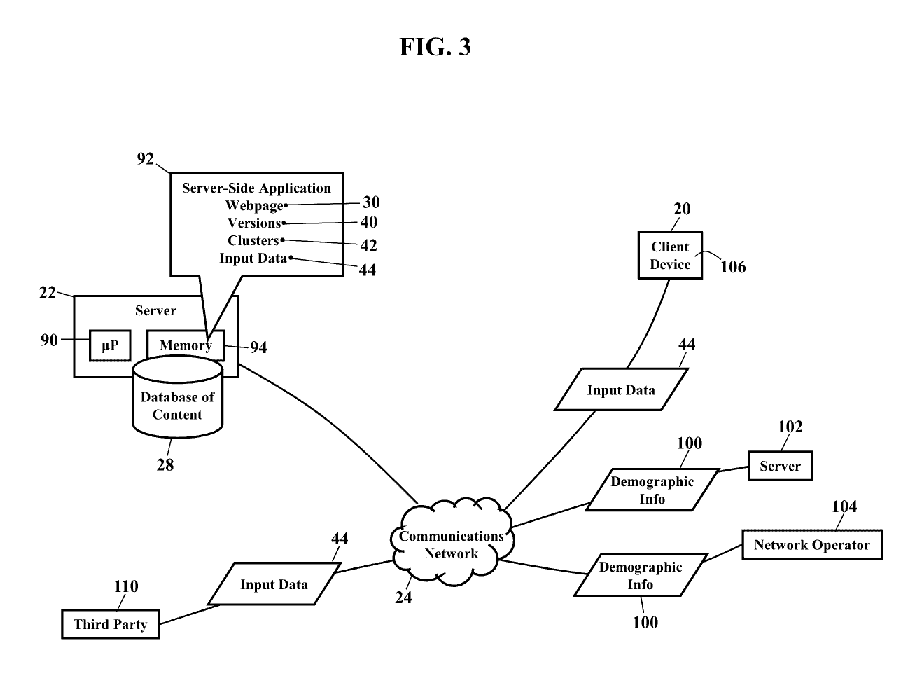

FIG. 3 illustrates the input data 44. There may be many sources for the input data 44, perhaps only limited by processing time and by resources. FIG. 3 thus illustrates only several exemplary sources of the input data 44. For example, some of the input data 44 may be retrieved from, or related to, the client device 20. Exemplary embodiments may receive the referral page, a display configuration, a window or screen configuration, a language identifier, a device identifier, a browser identifier, and the operating system. As this input data 44 may be obtained from, or derived from, the client device 20, the input data 44 represents any information that may be gleaned from usage of the software applications executed by the client device 20.

Other input data 44 may include demographic information 100. The demographic information 100 may be retrieved from any source, such as a customer's server 102 and/or network operator 104. For example, the demographic information 100 may be related to or associated with the Internet protocol network address 106 associated with the client device 20. The demographic information 100 may also be retrieved from user account information (such as address, cart inventory, order history, and behavioral data) and cookie files (such as browsing history and behavioral data).

Other input data 44 may be retrieved from other applications and/or websites. As the reader may understand, the client device 20 may execute many software applications and may interact with many servers hosting or storing web sites. Any of these “first party” and/or “third party” applications, servers, and/or websites may provide the input data 44. The client device 20, for example, may interact with social sites, shopping sites, mapping sites, news sites, search engines, and hundreds of other operators and entities. The input data 44 may even be aggregated across multiple sites. The input data 44 may even be combined or matched across different providers, such as service providers.

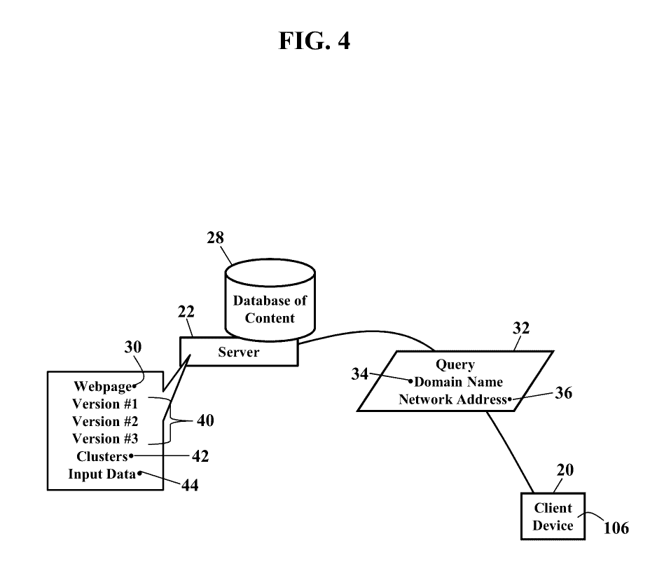

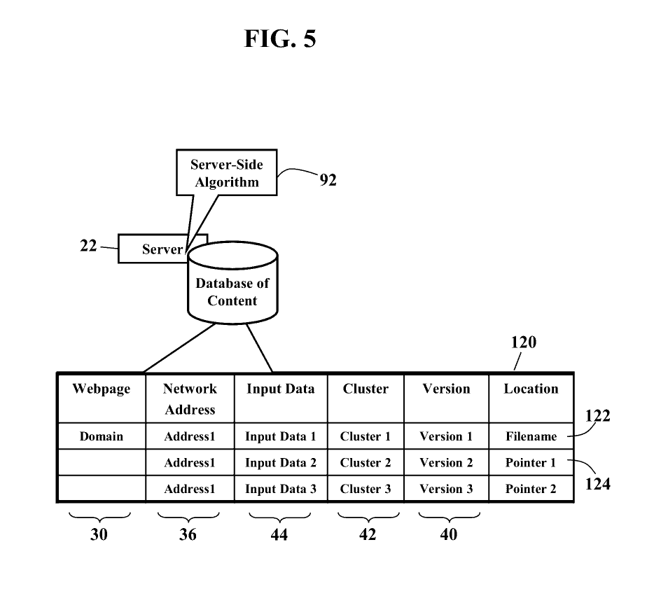

FIGS. 4-5 illustrate clustering. When the server 22 receives the query 32, the server 22 gathers the input data 44. The server 22 may then query the database 28 of content and retrieve the corresponding version 40 associated with the input data 44. That is, the server 22 retrieves the version 40 associated with the cluster 42 targeted to the input data 44. As there may be hundreds or thousands of different versions 40 associated with the same network address 36, the server 22 may use the input data 44 to determine the corresponding cluster 42.

FIG. 5 illustrates the database 28 content. The electronic database 28 content is illustrated as a table 120 that electronically maps, relates, or associates different input data 44 to different versions 40 associated with the webpage 30. As the reader may image, there may be thousands or even millions of different combinations of the input data 44. Exemplary embodiments, then, may associate different combinations of the input data 44 to one of the different clusters 42. That is, ranges and/or values of the input data 44 may be associated with one of the different clusters 42. Once the server-side application 92 instructs the server 22 to acquire the input data 44, the server-side application 92 causes the server 22 to compare the input data 44 to the ranges and/or values defined for each cluster 42. The server-side application 92 may thus select a database entry for the cluster 42 that best matches the input data 44. Once the cluster 42 is selected, the server-side application 92 may retrieve the corresponding database entry that is associated with the version 40 of the webpage 30. The server-side application 92 may thus retrieve a filename 122 or network pointer 124 associated with the version 40 of the webpage 30 that best suits the input data 44. Again, even though FIG. 5 only illustrates a few different versions 40 of the webpage, in practice the database 28 content may have hundreds, thousands, or even millions of entries.

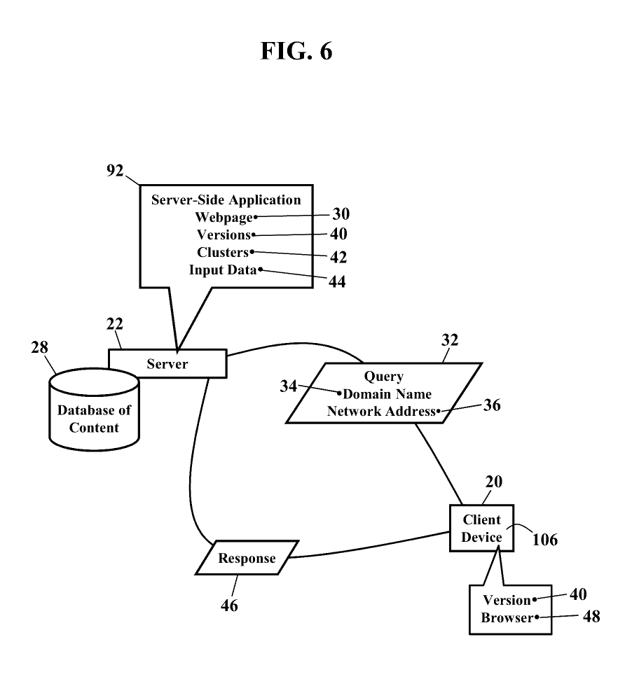

FIG. 6 illustrates the response 46. Once the version 40 of the webpage 30 is determined, the response 46 is sent to the client device 20. The response 46 includes the version 40 of the webpage 30 chosen based on the input data 44. The response 46 is sent to the network address associated with the client device 20. The client device 20 thus receives the version 40 of the webpage 30 as the response 46 to the query 32. The client device 20, in other words, audibly and/or visually presents the version 40 of the webpage 30 that best appeals to the user.

Each cluster 42 may thus be defined for different users. Each different version 40 may have a graphical layout, language, and/or content designed specifically to a different cluster 42 of users, according to the input data 44. Some of the clusters 42 may thus be defined to appeal to a large percentage or number of users, while other clusters 42 may be defined for small or even a minute percentage of users. Indeed, the version 40 may even be dynamically personalized for the particular user of the client device 20. Exemplary embodiments may thus server every customer with a unique version 40 of the webpage 30 personalized in real time, thus maximizing a probability that each customer will convert.

Conversion may be arbitrary. As exemplary embodiments offer hundreds or thousands of the different versions 40 of the webpage 30, each different version 40 may be tailored to a specific trait or goal. As a simple example, some users may respond better or more favorably to colors and/or screen placement of content features. Different layout versions 40 may thus be generated with different colors and placements, with each different version 40 targeted to a specific cluster 42 of users known to convert to that corresponding color/placement. In actual practice, of course, the different versions 40 may be much more complicated and tailored to appeal to a large matrix of conversion parameters. The terms “convert” and “conversion” thus include any parameter, criteria, or target that is considered a success. Some website operators, for example, may consider conversion to be the number of user's devices that click or select a specific graphical button or other control webpage. Another conversion parameter or metric may be financial measures or performance, such as textual descriptions of items added to an electronic shopping cart, actual purchases, and even purchases above a particular threshold. Simple conversion metrics may merely count or sum the number of website links selected to a referral page. Conversion is thus any target measurement an operators of the webpage 30 considers or defines as desirable.

Exemplary embodiments also include real time monitoring. The server-side application 92 controls where customer requests get routed, while providing a company with a comprehensive dashboard giving real-time statistics and manual override mechanisms. The different versions 40 may thus be dynamically managed and changed as different versions 40 go online and offline.

Exemplary embodiments may also expose metadata. Exemplary embodiments provide a solution that manages the entire routing of customer traffic. Exemplary embodiments may also expose metadata which may be used to manage a custom customer experience (whether it's content or a user interface design) on their own. For example, if exemplary embodiments determine a certain end user has an affinity for sports, content can be catered to this interest.

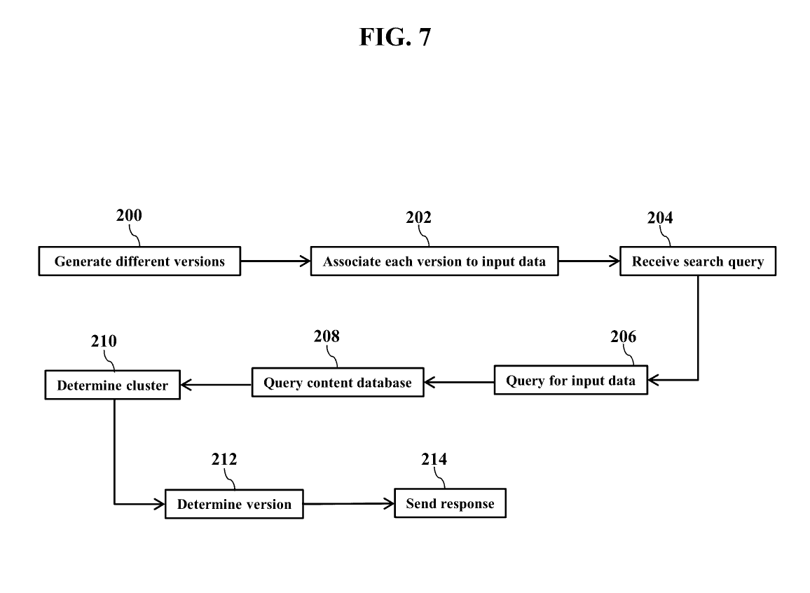

FIG. 7 is a flowchart illustrating a method or algorithm for clustering the versions 40 of the webpage 30, according to exemplary embodiments. The different versions 40 of the webpage 30 are generated (Block 200). Each different version 40 may be associated to a different combination and/or range of the input data 44 (Block 202). The search query 32 is received (Block 204) and the input data is/are received (Block 206). The database 28 of content is queried (Block 208), the corresponding cluster 42 is determined (Block 210), and the corresponding version 40 is determined (Block 212). The corresponding version 40 is sent as the response 46 to the query 32 (Block 214).

Exemplary embodiments may be physically embodied on or in a processor-readable device or storage medium. For example, exemplary embodiments may include CD-ROM, DVD, tape, cassette, floppy disk, optical disk, memory card, memory drive, and large-capacity disks.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method performed by a server to resolve different versions of a webpage, the method comprising:
receiving, by the server, an electronic query sent via the Internet from a device, the electronic query specifying a domain name associated with a webpage;
determining, by the server, a cluster associated with the device;
querying, by the server, an electronic database for the cluster associated with the device, the electronic database having electronic associations between the different versions of the webpage and different clusters;
retrieving, by the server, a version of the different versions of the webpage from the electronic database, the version of the webpage having an electronic association with the cluster associated with the device; and
sending, by the server, the version of the webpage via the Internet to the device, the version of the webpage sent as a response to the electronic query specifying the domain name.

2. The method of claim 1, further comprising resolving the domain name into an address.

3. The method of claim 1, further comprising determining the cluster based on a referral page.

4. The method of claim 1, further comprising determining the cluster based on a display configuration associated with the device.

5. The method of claim 1, further comprising determining the cluster based on a window configuration associated with a software application executed by the device.

6. The method of claim 1, further comprising determining the cluster based on a language identifier associated with the device.

7. The method of claim 1, further comprising determining the cluster based on a software application executed by the device.

8. The method of claim 1, further comprising determining the cluster based on a browser application executed by the device.

9. The method of claim 1, further comprising determining the cluster based on an operating system executed by the device.

10. The method of claim 1, further comprising determining the cluster based on a demographic associated with the device.

11. The method of claim 1, further comprising determining the cluster based on an Internet protocol address associated with the device, such that the electronic database has the electronic associations between the different versions of the webpage and the different clusters associated with Internet protocol addresses.

12. A system, comprising:
a hardware processor; and
a memory device, the memory device storing code, the code when executed causing the hardware processor to perform operations, the operations comprising:
receiving an electronic query sent via the Internet from a device, the electronic query specifying a domain name associated with a webpage;
determining a cluster associated with the device;
querying an electronic database for the cluster associated with the device, the electronic database having electronic associations between different versions of the webpage and different clusters;
retrieving a version of the different versions of the webpage from the electronic database, the version of the webpage having an electronic association with the cluster associated with the device; and
sending the version of the webpage via the Internet to the device, the version of the webpage sent as a response to the electronic query specifying the domain name.

13. The system of claim 12, wherein the operations further comprise resolving the domain name into an address.

14. The system of claim 12, wherein the operations further comprise determining the cluster based on a referral page.

15. The system of claim 12, wherein the operations further comprise determining the cluster based on a display configuration associated with the device.

16. The system of claim 12, wherein the operations further comprise determining the cluster based on a window configuration associated with a software application executed by the device.

17. The system of claim 12, wherein the operations further comprise determining the cluster based on a language identifier associated with the device.

18. The system of claim 12, wherein the operations further comprise determining the cluster based on a purchase associated with the device, such that the electronic database has the electronic associations between the different versions of the webpage and the different clusters associated with purchases.

19. The system of claim 12, wherein the operations further comprise determining the cluster based on postings to social networking websites, such that the electronic database has the electronic associations between the different versions of the webpage and the different clusters associated with the social networking websites.

20. A memory device storing instructions that when executed cause a hardware processor to perform operations, the operations comprising:
receiving an electronic query sent via the Internet from a device, the electronic query specifying a domain name associated with a webpage;
determining a cluster associated with the device;
querying an electronic database for the cluster associated with the device, the electronic database having electronic associations between different versions of the webpage and different clusters;
retrieving a version of the different versions of the webpage from the electronic database, the version of the webpage having an electronic association with the cluster associated with the device; and
sending the version of the webpage via the Internet to the device, the version of the webpage sent as a response to the electronic query specifying the domain name.
